(19) United States
(12) Patent Application Publication
(10) Pub. No.: US 2009/0308302 A1
(43) Pub. Date: Dec. 17, 2009

(54) Cable identification system

(76) Inventor: Albert A. Burlando, Flanders, NJ (US)

Correspondence Address: DAY PITNEY LLP, 7 TIMES SQUARE, NEW YORK, NY, 10036-7311, US

(21) Appl. No.: 12/157,940

(22) Filed: Jun. 13, 2008

(51) Int. Cl. G01D 21/00

(52) U.S. Cl. 116/209

(57) ABSTRACT

A cable identification system for locating and identifying an elongated cable includes a first elongated tape member and a second elongated tape member joined together at a hinge angle. The elongated marker is provided with a plurality of longitudinally spaced slot portions and a plurality of longitudinally spaced tab portions. The elongated marker has a lower vertical portion with about a 180° hinge angle and fixed connection to a cable and an upper portion with a selected hinge angle for extension thereof either above a ground level of a backfilled trench in a vertical direction, or below and parallel to the ground level of the backfilled trench in a horizontal direction.

### BACKGROUND OF THE INVENTION

1. Field of the Invention

This invention relates to a cable identification system, and, more particularly, to a cable identification system having an elongated marker including first and second elongated tape members joined by an elongated hinge portion.

2. Description of the Prior Art

The cable identification system of the prior art has an elongated marker, which includes an elongated tape with information marked thereon, and which is disposed in a backfilled trench above a cable and below ground level.

One problem with such prior-art markers is that there is no way to locate and identify a cable visually before excavating the backfill covering the cable and reading the marker tape information. Aluminum foil laminates, detectable with a metal detector, were developed, but the aluminum was subject to corrosion due to salts and acids in the ground. Additionally, the path of the trench in which the cable is buried is gradually taken over by ground cover, such as trees and shrubs, making it difficult to determine the location of the trench.

### SUMMARY OF THE INVENTION

Accordingly, the present invention is a cable identification system comprised of an elongated marker having a first elongated tape member and a second elongated tape member joined together at a hinge angle, wherein the elongated marker is provided with a plurality of longitudinally spaced slot portions and a plurality of longitudinally spaced tab portions. The elongated marker has a lower vertical portion with about a 180° hinge angle and a fixed connection to a cable. The elongated marker also has an upper portion with a selected hinge angle for extension thereof either above a ground level of a backfilled trench in a vertical direction, or below and parallel to the ground level of the backfilled trench in a horizontal direction.

### BRIEF DESCRIPTION OF THE DRAWINGS

A better understanding of the present invention, as well as other advantages thereof, will become apparent upon consideration of the detailed disclosure below, especially when taken with the accompanying drawings wherein:

FIG. 1 is a plan view of a flattened, unfolded marker of a cable identification system according to the present invention;

FIG. 2 is a sectional view as taken along the line 2-2 of FIG. 1;

FIG. 3 is a sectional view of one embodiment of a cable identification system according to the invention;

FIG. 4 is a perspective view of another embodiment of a cable identification system according to the present invention; and

FIG. 5 is a sectional view of still another embodiment of a cable identification system according to the invention.

### DETAILED DESCRIPTION OF THE PREFERRED EMBODIMENTS

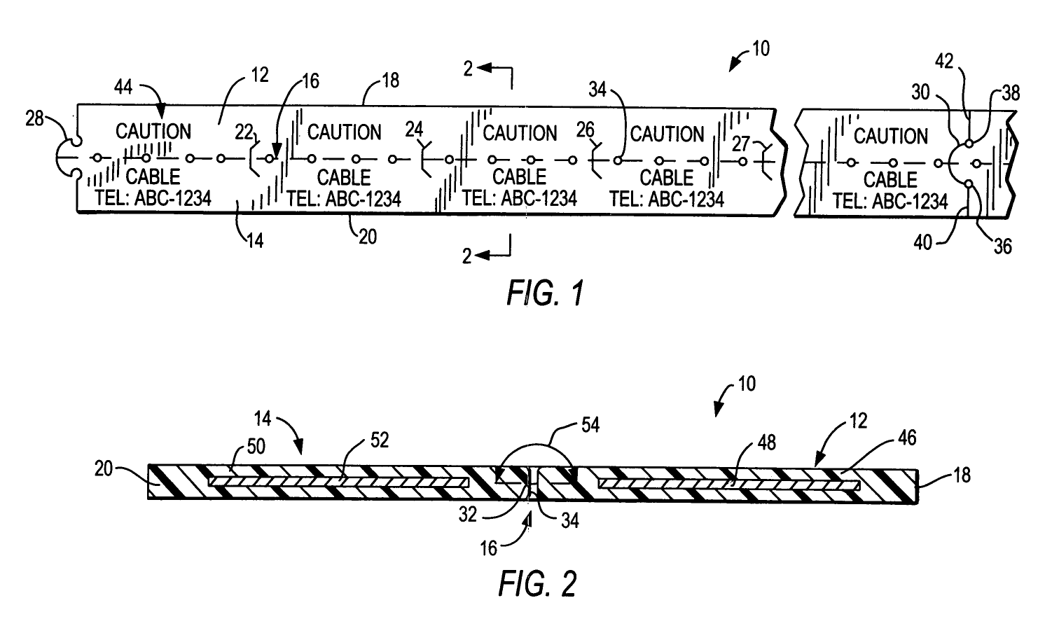

As shown in FIGS. 1, 2, and 3, a marker or marker assembly 10 for a cable identification system 8 is provided. In FIG. 1, the marker 10 is shown in a flattened, unfolded condition for ease of illustration. The marker 10 includes a first elongated tape or plate portion 12, and a second elongated tape or plate portion 14, and a third elongate, flexible hinge portion 16 which is disposed between and is joined to the first elongated tape 12 and the second elongated tape 14. The first elongated tape 12 has an exterior edge portion 18, and second tape 14 has an exterior edge portion 20.

The marker 10 is provided with a plurality of longitudinally spaced slots or slot portions 22, 24, 26, and 27, and a plurality of longitudinally spaced tabs or tab portions 28 and 30. The hinge portion 16, referring to FIG. 2, has a hinge axis 32 and a plurality of longitudinally spaced perforations 34 for ease of folding the first elongated tape 12 toward the second elongated tape 14. Tab portion 30, which is a typical tab portion, is comprised of two tab holes 36 and 38 and two cut lines 40 and 42 for cutting the marker 10 into separate and discrete lengths. The marker 10 is provided with printed information, caution markings, or warning signs 44, which are longitudinally spaced along its length.

Referring to FIG. 2, the first elongated tape 12 is a composite structure and includes an exterior plastic strip or cover 46 and an interior metal strip 48. The second elongated tape 14 also includes an exterior plastic strip 50 and an interior metal strip 52. The plastic strips 46 and 50 are formed of a thermoplastic material, such as polyethylene or the like, and may be color-coded to indicate the type of cable or conduit the marker 10 is being used to identify in addition to the signs 44 thereon. The metal strips 48 and 52 are formed of aluminum or the like. The hinge portion 16 is of like material as the plastic strips 46 and 50. The first elongated tape 12 and the second elongated tape 14 are foldable about hinge axis 32 and at a hinge angle 54.

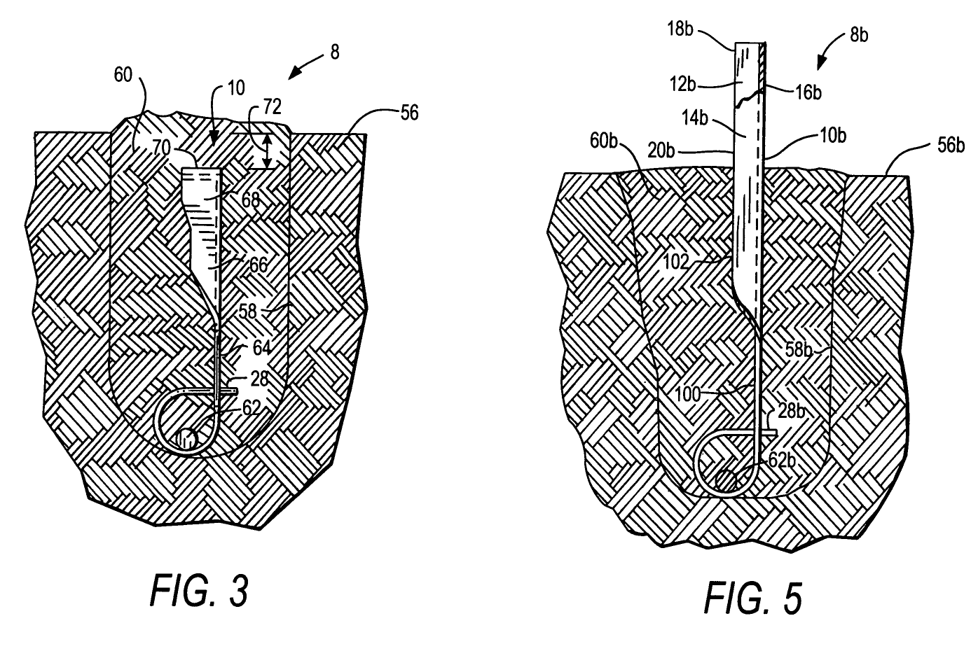

In FIG. 3, the marker 10 is disposed below ground level 56 in a trench 58, which has backfill 60. A cable 62, such as a fiber optic cable, is disposed at the bottom of trench 58. The marker 10 is comprised of partly folded, lower vertical portion 64 enclosed at a hinge angle 54 of about 180°, a middle vertical portion 66 at a hinge angle 54 of about 90°, an upper vertical portion 68 at a hinge angle 54 of 0° and a folded over horizontal portion 70 at a hinge angle 54 of 0°. The horizontal portion 70 is disposed at a depth 72 below the ground level 56. The lower vertical portion 64 encircles the cable 62 with the tab 28 received or positioned in the slot 22. As backfill is placed in trench 58, a tension force is applied upwardly on the upper vertical portion 68 so that the tab portion 28 is substantially parallel to the slot portion 22 in teardrop shape, thereby locking the tab 28 into the slot 22.

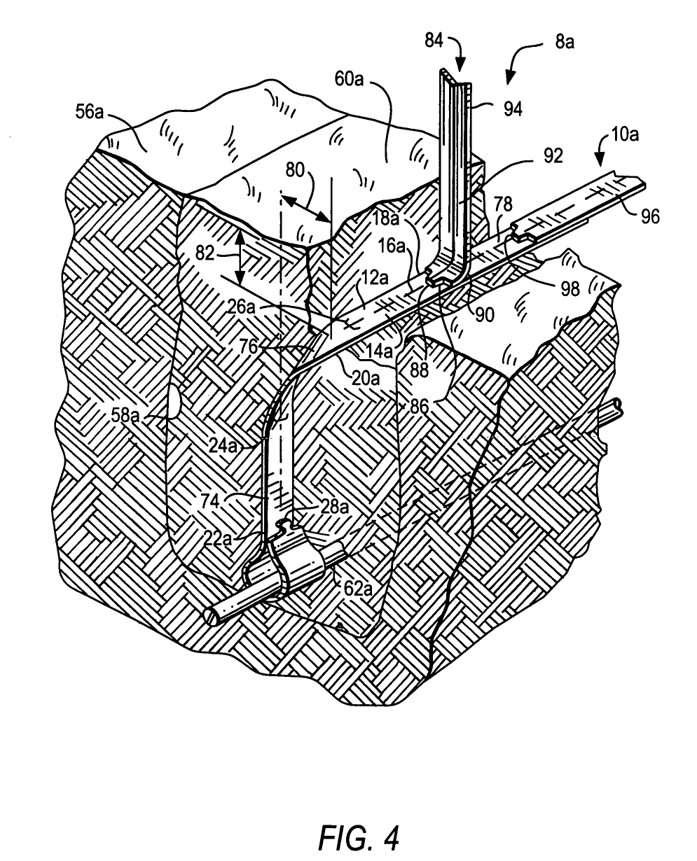

Referring to FIG. 4, there is illustrated another embodiment of the present invention with like parts of FIGS. 1, 2, and 3, having like numerals but with a subscript “a” added thereto.

The marker 10a for cable identification system 8a comprises a first elongated tape 12a, a second elongated tape 14a and an elongated hinge portion 16a. The first elongated tape 12a is formed with an outer edge portion 18a; the second elongated tape 14a is likewise formed with an outer edge portion 20a. The marker 10a is provided with slots 22a, 24a, 26a and a tab 28a to be positioned in slot 22a. The marker 10a is disposed below ground level 56a in a trench 58a with backfill 60a shown in FIG. 4 in a schematic fashion. A cable 62a is disposed at the bottom of trench 58a.

The marker 10a is comprised of a lower vertical portion 74 at a hinge angle of 180° with an upper horizontal portion 78 at a hinge angle of 180°. The horizontal portion 78 is disposed at a depth 82 below the ground level 56a, and is offset at a small distance 80 from a vertical line through the hinge axis of lower vertical portion 74. The offset distance 80 is required for making a smooth transition in the curved portion 76 from the vertical portion 74 to the horizontal portion 78 thereof.

The marker 10a is provided with a spaced apart vertical flag 84, comprised of a separate piece that is mounted to the horizontal portion 78. The vertical flag 84 is comprised of a lower horizontal portion 88 disposed at the depth 82 parallel to the horizontal portion 78 and received in a slot next to slot 26a. The flag portion 84 includes a curved portion 90 below the ground level 56a, a lower vertical portion 92 at a hinge angle 54 of 180°, and an upper vertical portion 94 at a hinge angle 54 of about 90° disposed above ground level 56a. The marker 10a also includes a separate, continuation piece 96 overlapping horizontal portion 78 and which has a tab 98 disposed in a slot in horizontal portion 78.

Still another embodiment is shown in FIG. 5, wherein like parts of FIG. 5, as parts of FIGS. 1, 2, and 3, are of like numerals but with a subscript “b” added thereto. The marker 10b for the cable identification system 8b is comprised of a first elongated tape 12b, a second elongated tape 14b and an elongated hinge portion 16b. The first elongated tape 12b includes an outer edge portion 18b; the second elongated tape 14b includes an outer edge portion 20b. The marker 10b is formed with slot portions (not shown) to receive tab 28b. The marker 10b is disposed below ground level 56b in a trench 58b with backfill 60b. A cable 62b is disposed at the bottom of the trench 58b.

The marker 10b is comprised of a lower vertical portion 100 at a hinge angle 54 of 180°, an upper vertical portion 102 at a hinge angle 54 of 90°. By applying a tension force on the upper vertical portion 102 during placement of backfill 60b around the lower vertical portion 100, the tab 28b is disposed parallel to the lower vertical portion 100 to lock tab 28b.

In construction, the marker 10 is available as a continuous roll in lengths of about 500 feet. Separate pieces are made by cutting at a tab portion 30 along trim lines 40 and 42 in a typical case.

The first elongated tape 12 and the second elongated tape 14 include plastic strips 46, 50, such as of polyethylene, on the exterior thereof, and metal strips 48, 52, respectively, such as of aluminum, on the interior thereof, so that the edges of metal strips 48, 52 are protected from corrosive elements in backfill 60. Alternate materials for the plastic strips 46, 50 are mylar, polyester and polypropylene. The metal strip 48 in the first elongated tape 12 and the metal strip 52 in the second elongated tape 14 allow a low voltage electric charge to pass therethrough which affects an electric field detectable by an above-ground voltage reading detector in order to pinpoint the route of cable 62 for maintenance and repair. Electrical voltage measuring equipment may also be used for detecting metal strips 48 and 52. If a break occurs in the metal strip 48 or 52, the location of the break can be determined through measurements of the resistance of the metal strip 48 or 52.

The vertical flag or marker 84 or 102 extends above ground level 56 for identifying and locating the cable 62a and 62b. The flag 84 includes a tab 86 received in a slot of the horizontal portion 78. The tab portions 28 and 30 and slot portions 22, 24, 26 and 27 are punched into the marker 10 during the manufacture thereof. The tab 30 may be formed in the field by cutting along lines 40 and 42 to holes 36 and 38 with a scissor or knife. The tab 98 of second marker 96 can also be made in the field for extending the marker 10. The vertical portion 94 of the flag 84 and the vertical portion 102 of the flag or marker 10b may be held upright, in tension, as backfill 60a or 60b is placed in trench 58a or 58b. The vertical flag 84 in FIG. 4 is positioned so that horizontal portion 88 is relatively long. As backfill 60a is placed above the horizontal portion 78, the horizontal portion 88 is parallel to the horizontal portion 78, so that a tension force applied to upper portion 94 causes a tension force in the horizontal portion 88 for locking tab 86 in place in its slot.

In FIGS. 3, 4, and 5, the backfill is placed around the cable 62, 62a, 62b after a tab 28, 28a, 28b is inserted into its slot to form a teardrop-shaped loop around the cable. In FIG. 4, backfill is placed up to the underside of the horizontal portion 78. In this way, the tension force in the vertical portion 74 and the tension force applied to the horizontal portion 78 form a resultant force at curved portion 76, which is resisted by a reaction force from the backfill under the curved portion 76. Similarly, in FIG. 3, the tension force applied to the horizontal portion 70 and the tension force in upper vertical portion 68 is resisted by a reaction force from the backfill under the L-shaped bend between the portions 68 and 70.

Caution marking 44, a warning message, is spaced longitudinally at about one foot spacing along the marker 10. The slot portions 22, 24, 26 and 27 are longitudinally spaced at about one foot spacing. The tab 28 and 30 is longitudinally spaced at about a three- to five-foot spacing.

The perforations 34 in the hinged portion 16 allow a hinge action, so that an installer can bend the portion 12 toward the portion 14 about a hinge axis 32 to a hinge angle 54 of 90° to provide a rigid column structure 66 as in FIG. 3. Also, a rigid column structure is formed in portion 94 of the cable identification system 8a in FIG. 4. In addition, in FIG. 5, a rigid column structure is formed in the portion 102 above the ground level 56b. The portions 94 and 102 extend about one to two feet above ground level 56a and 56b. The thickness of the plastic at the hinge portion is about 0.040 inch. The vertical markers 84 may be placed about three feet apart or at a greater spacing as desired, as there is a slot approximately every foot in the horizontal portion 78. The marker 10 also may be used as a barricade warning tape, as desired, to identify an open trench during construction.

The advantages of the cable identification system 8 of the present invention include the following:

Firstly, by using marker 10 having an elongated hinge portion 16 capable of a variable hinge angle 54, a columnar flag structure of L-shaped section above ground is provided in order to locate and identify a cable 62 before excavation of trench backfill;

Secondly, by using a series of slots 22, 24, 26 and 27 and tabs 28 and 30, the columnar flag structure 102 in FIG. 5 can be anchored to cable 62b; and the columnar flag structure 84 in FIG. 4 can be anchored to horizontal portion 78, anchored through the vertical portion 74 to the cable 62a; and

Thirdly, by anchoring one end of the marker 10 or 10a or 10b to the respective cables 62, 62a and 62b, tension force can be applied to the opposite end of the marker for ease of installation of the marker while backfilling the trench.

While the present invention has been described in three preferred embodiments, it is understood by one skilled in the art that the present invention may be used in other embodiments. It will be understood that many modifications will be apparent to those of ordinary skill in the art and that the application is intended to cover any adaptations or variations thereof. Therefore, it is manifestly intended that this invention be only limited by the claims and the equivalents thereof.

What is claimed is:

1. A cable identification system for locating and identifying an elongate cable disposed below ground level in a trench having backfill comprising:
an elongated marker having a first elongated tape member and a second elongated tape member and an elongated hinge portion disposed between and joining together at a hinge angle the first elongated tape member and the second elongated tape member;
said elongated marker having a plurality of longitudinally spaced slot portions and having a plurality of longitudinally spaced tab portions for anchoring an end portion of the elongated marker to the cable;
said elongated marker having a lower vertical portion with about a 180° hinge angle and with a fixed connection to the elongate cable; and
said elongated marker having an upper portion for disposition of the upper portion as desired either above or below and parallel to the ground level in a horizontal direction.

2. The system of claim 1 including:
a vertical flag member having a flag horizontal portion with a tab portion received in a slot portion of the elongated marker, and having a flag lower vertical portion with about a 180° hinge angle, and having a flag upper vertical portion with a hinge angle of about 90°.

3. The system of claim 1 including:
a second marker having a tab portion received in a slot portion of the first marker for extending the length of the system.

4. The system of claim 1 wherein the lower vertical portion of the elongated marker has a tab portion, said tab portion extending around the cable and through a slot portion in the lower vertical portion, for forming the fixed connection which anchors an end of the elongated marker to the cable.

5. The system of claim 1 wherein the first tape portion and the second tape portion, each includes an enclosing exterior plastic strip and an interior metal strip, and wherein the hinge portion includes a plastic strip with a line of perforations along a hinge axis.

6. The system of claim 1 wherein the marker has a plurality of warning signs placed thereon at a selected longitudinal spacing.

7. The system of claim 1 wherein said upper portion of the elongated marker includes:
a first vertical portion with a hinge angle of about 90°;
a second vertical portion with a hinge angle of about 0° connected to the second vertical portion.

8. The system of claim 1 wherein said upper portion of the elongated marker includes:
a curved portion with a hinge angle of about 180°; and
an upper horizontal portion with a hinge angle of about 180° connected to the curved portion.

9. The system of claim 1 wherein said upper portion of the elongated marker includes:
an upper vertical portion with a hinge angle of less than 180°.
